(19) United States
(12) Patent Application Publication
(10) Pub. No.: US 2010/0202699 A1
(43) Pub. Date: Aug. 12, 2010

(54) IMAGE PROCESSING FOR CHANGING PREDETERMINED TEXTURE CHARACTERISTIC AMOUNT OF FACE IMAGE

(75) Inventors: Kenji Matsuzaka, Shiojiri-shi (JP); Masaya Usui, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/703,693

(22) Filed: Feb. 10, 2010

(30) Foreign Application Priority Data
Feb. 12, 2009 (JP) 2009-029380

(51) Int. Cl. G06K 9/54; G06K 9/46

(52) U.S. Cl. 382/195; 382/307

(57) ABSTRACT

Image processing apparatus and methods are provided for changing a texture amount of a face image. A method includes specifying positions of predetermined characteristic portions of the face image, determining a size of the face image, selecting a reference face shape based on the determined face image size, selecting a texture model corresponding to the selected reference face shape, performing a first transformation of the face image such that the resulting transformed face image shape matches the selected reference shape, changing the texture characteristic amount by using the selected texture model, and transforming the changed face image via an inverse transformation of the first transformation.

### CROSS-REFERENCES TO RELATED APPLICATIONS

Priority is claimed under 35 U.S.C. §119 to Japanese Application No. 2009-029380 filed on Feb. 12, 2009 which is hereby incorporated by reference in its entirety.

The present application is related to U.S. application Ser. No. ______, entitled “Specifying Position of Characteristic Portion of Face Image,” filed on ______, (Attorney Docket No. 21654P-026100US); U.S. Application No., entitled “Image Processing Apparatus For Detecting Coordinate Positions of Characteristic Portions of Face,” filed on ______, (Attorney Docket No. 21654P-026800US); and U.S. application Ser. No. ______, entitled “Image Processing Apparatus For Detecting Coordinate Position of Characteristic Portion of Face Image,” filed on ______, (Attorney Docket No. 21654P-026900US); the full disclosures of which are incorporated herein by reference.

### BACKGROUND

1. Technical Field

The present invention relates to image processing for changing a predetermined texture characteristic amount of a face image.

2. Related Art

An active appearance model technique (also abbreviated as “AAM”) has been used to model a visual event. In the AAM technique, a face image is, for example, modeled by using a shape model that represents the face shape by using positions of characteristic portions of the face and a texture model that represents the “appearance” in an average face shape. The shape model and the texture model can be created, for example, by performing statistical analysis on the positions (e.g., coordinates) and pixel values (for example, luminance values) of predetermined characteristic portions (for example, an eye area, a nose tip, and a face line) of a plurality of sample face images. Using the AAM technique, any arbitrary face image can be modeled (synthesized), and the positions of the characteristic portions in a face image can be specified (detected) (for example, see JP-A-2007-141107).

When the AAM technique is used, image processing (for example, image processing for decreasing a shadow component) for changing a predetermined texture characteristic amount of a face image can be performed by changing a predetermined texture parameter of a texture model. In typical image processing for changing a predetermined texture characteristic amount of a face image, there is room for improving the quality of the resulting image.

In addition, it may be desirable to improve the resulting image quality in many instances where image processing is used to change a predetermined texture characteristic amount of a face image.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description located below.

The present invention provides image processing apparatus and methods for improving the quality of image processing for changing a predetermined texture characteristic amount of a face image.

Thus, in a first aspect, an image processing apparatus is provided that changes a predetermined texture characteristic amount of a face image in a target image. The image processing apparatus includes a memory unit that stores information used for specifying a plurality of reference face shapes and a plurality of texture models corresponding to different face image sizes, a face characteristic position specifying unit that specifies a position of a predetermined characteristic portion of a face in the target image, a model selection unit that acquires the face image size in the target image and selects one reference shape and one texture model based on the acquired face image size, a first image transforming unit that performs a first transformation for the target image such that the face shape defined by the positions of characteristic portions in the resulting transformed image matches the selected reference shape, a characteristic amount processing unit that changes the predetermined texture characteristic amount of the target image after the first transformation by using the selected texture model, and a second image transforming unit that performs an inverse transformation of the first transformation for the image in which the predetermined texture characteristic amount has been changed. The plurality of reference shapes are face shapes used as references, corresponding to different face image sizes. A face texture is defined by pixel values of a face image having the reference shape, by using a reference texture and at least one texture characteristic amount therein.

According to the above-described image processing apparatus, one reference shape and one texture model are selected based on the face image size in the target image, and the first transformation is performed such that the resulting transformed face image matches the selected reference shape. Then, a predetermined texture characteristic amount of the transformed face image is changed by using the selected texture model, and the inverse transformation of the first transformation is performed on the transformed face image in which the characteristic amount has been changed. As a result, the predetermined texture characteristic amount of the face image included in the target image is changed. In this image processing apparatus, since the reference shape and the texture model are selected based on the face image size in the target image, a decrease in the amount of information on the target image can be suppressed at the time when the first transformation, the inverse transformation thereof, and/or the change of the texture characteristic amount using the texture model are performed. Therefore, the quality of the image processing for changing the predetermined texture characteristic amount of a face image may be improved.

In many embodiments, the model selection unit is configured to select the reference shape and the texture model corresponding to a face image size that is closest to the acquired face image size.

In such a case, the reference shape and the texture model corresponding to a face image size that is the closest to the face image size in the target image are selected. Accordingly, a decrease in the amount of information on the target image can be suppressed at the time when the first transformation, the inverse transformation thereof, and/or the change of the texture characteristic amount using the texture model are performed. Therefore, the quality of the image processing for changing the predetermined texture characteristic amount of a face image may be improved.

In many embodiments, the characteristic amount processing unit, by using the selected texture model, is configured to specify a face texture of the target image after the first transformation and change the predetermined texture characteristic amount of the specified face texture.

In such a case, a decrease in the amount of information on the image may be suppressed at the time when the texture characteristic amount is changed by using the texture model. Accordingly, the quality of the image processing for changing the predetermined texture characteristic amount of a face image may be improved.

In many embodiments, the characteristic amount processing unit is configured to change the predetermined texture characteristic amount that is substantially in correspondence with a shadow component.

In such a case, the quality of the image processing for changing the predetermined texture characteristic amount of a face image that is substantially in correspondence with the shadow component may be improved.

In many embodiments, the model selection unit is configured to acquire the face image size in the target image based on the position of the characteristic portion that is specified for the target image.

In such a case, the face image size in the target image is acquired based on the position of the characteristic portion that is specified for the target image, and one reference shape and one texture model are selected based on the face image size in the target image. Accordingly, a decrease in the amount of information on the image may be suppressed at the time when the first transformation, the inverse transformation thereof, and/or the change of the texture characteristic amount using the texture model are performed. Therefore, the quality of the image processing for changing the predetermined texture characteristic amount of a face image may be improved.

In many embodiments, the information stored in the memory unit includes a shape model that represents the face shape by using the reference shape and at least one shape characteristic amount and includes information for specifying a plurality of the shape models corresponding to different face image sizes. And the face characteristic position specifying unit specifies the position of the characteristic portion in the target image by using a shape model and a texture model.

In such a case, the position of the characteristic portion in the target image is specified by using a shape model and a texture model. Accordingly, the quality of the image processing for changing the predetermined texture characteristic amount of a face image by using the result of the specification may be improved.

In many embodiments, the shape model and the texture model are based on statistical analysis of a plurality of sample face images of which the positions of the characteristic portions are known.

In such a case, the position of the characteristic portion in the target image may be specified with high accuracy by using the shape model and the texture model.

In many embodiments, the reference shape is an average shape that represents an average position of the characteristic portions of the plurality of sample face images. And the reference texture is an average texture that represents an average of pixel values in the positions of the characteristic portions of the plurality of transformed sample face images, which are the sample face images transformed into the average shape.

In such a case, the quality of the image processing for changing the predetermined texture characteristic amount of a face image may be improved.

In another aspect, an image processing apparatus is provided that changes a predetermined texture characteristic amount of a face image in a target image. The image processing apparatus includes a memory unit that stores information used for specifying a reference shape that is a face image used as a reference and a texture model that represents a face texture, a face characteristic position specifying unit that specifies a position of a predetermined characteristic portion of a face in the target image, a first image transforming unit that performs a first transformation for the target image such that the face shape defined by the position of the characteristic portion in the transformed target image is identical to the reference shape, a characteristic amount processing unit that generates a texture characteristic amount image corresponding to the predetermined texture characteristic amount of the target image after the first transformation by using the texture model, a second image transforming unit that performs an inverse transformation of the first transformation for the texture characteristic amount image, and a correction processing unit that subtracts the texture characteristic amount image after the inversion transformation from the target image. A face texture is defined by pixel values of a face image having the reference shape, by using a reference texture and at least one texture characteristic amount therein.

According to the above-described image processing apparatus, the first transformation is performed such that the face shape included in the transformed target image is identical to the reference shape. And a texture characteristic amount image corresponding to a predetermined texture characteristic amount of the target image after the first transformation is generated by using the texture model. Then, the inverse transformation of the first transformation is performed for the texture characteristic amount image, and the texture characteristic amount image after the inverse transformation is subtracted from the target image. As a result, the predetermined texture characteristic amount of a face image included in the target image is changed. According to this image processing apparatus, the first transformation or the inverse transformation is not performed for the target image that is used for the final subtraction. Accordingly, a decrease in the amount of information of an image can be suppressed, whereby the quality of the image processing for changing the predetermined texture characteristic amount of a face image may be improved.

In another aspect, an image processing apparatus is provided that changes a predetermined texture characteristic amount of a face image in a target image. The image processing apparatus includes a processor, and a machine readable memory coupled with the processor. The machine readable memory includes information used for specifying a plurality of reference face shapes corresponding to different face image sizes, and a plurality of texture models. Each of the texture models corresponds to one of the plurality of reference face shapes and is defined by pixel values of a face image having the corresponding reference face shape. Each texture model includes a reference texture and at least one texture characteristic amount therein. The machine readable memory also includes program instructions for execution by the processor. The program instructions, when executed, cause the processor to specify positions of predetermined characteristic portions of the face image in the target image, determine a size of the face image in the target image, select one of the reference face shapes based on the determined face image size, select a texture model corresponding to the selected reference face shape from the plurality of texture models, perform a first transformation of the face image in the target image such that a face shape defined by the positions of characteristic portions in the resulting transformed face image is identical to the selected reference face shape, change the predetermined texture characteristic amount of the transformed face image by using the selected texture model, and perform a second transformation of the transformed face image having the changed predetermined texture characteristic amount. The second transformation is the inverse of the first transformation.

In many embodiments, the selected reference face shape and the selected texture model correspond to a face image size that is closest to the determined face image size.

In many embodiments, the selected texture model is used to generate texture characteristic amounts for the transformed face image. And the generated texture characteristic amounts include the predetermined texture characteristic amount.

In many embodiments, the predetermined texture characteristic amount substantially corresponds to a shadow component.

In many embodiments, the face image size in the target image is determined based on the specified positions of the characteristic portions of the face image in the target image.

In many embodiments, the information used for specifying a plurality of reference face shapes includes a plurality of shape models, each shape model representing a face shape by using one of the reference face shapes and at least one shape characteristic amount, the plurality of reference face shapes including face shapes having different face image sizes. And in many embodiments, the positions of the characteristic portions of the face image in the target image are specified by using a selected shape model and the selected texture model.

In many embodiments, the selected shape model and the selected texture model were created based on statistical analysis of a plurality of sample face images of which the positions of the characteristic portions are known.

In many embodiments, the selected reference face shape is an average shape that represents average positions of the characteristic portions of the plurality of sample face images. And in many embodiments, the selected texture model includes a reference texture that includes averages of pixel values of a plurality of transformed sample face images generated by transforming each of the plurality of sample face images into the average shape.

In addition, the invention can be implemented in various forms. For example, the invention can be implemented in the forms of an image processing method, an image processing apparatus, an image correction method, an image correction apparatus, a characteristic amount changing method, a characteristic amount changing apparatus, a printing method, and a printing apparatus, and a computer program for implementing the functions of the above-described method or apparatus, a recording medium having the computer program recorded thereon, a data signal implemented in a carrier wave including the computer program, and the like.

In another aspect, an image processing method is provided for changing a predetermined texture characteristic amount of a face image in a target image. The image processing method includes specifying positions of predetermined characteristic portions of the face image in the target image, determining a size of the face image in the target image, selecting one of a plurality of reference face shapes corresponding to different face image sizes based on the determined face image size, selecting a texture model corresponding to the selected reference face shape from a plurality of texture models, performing a first transformation of the face image in the target image such that a face shape defined by the positions of characteristic portions in the resulting transformed face image is identical to the selected reference shape, changing the predetermined texture characteristic amount of the transformed face image by using the selected texture model, and performing a second transformation of the transformed face image having the changed predetermined texture characteristic amount. The second transformation is the inverse of the first transformation. Each of the plurality of texture models includes a reference texture and at least one texture characteristic amount therein.

In many embodiments, the method further includes acquiring information used for specifying the plurality of reference face shapes and the plurality of texture models. In many embodiments, each texture model is defined by pixel values of a face image having the shape of one of the reference face shapes.

In another aspect, an image processing method is provided for changing at least one predetermined texture characteristic amount of a face image in a target image. The image processing method includes specifying positions of predetermined characteristic portions of the face image in the target image, performing a first transformation of the face image such that a face shape defined by the positions of the characteristic portions in the resulting transformed face image is identical to a predetermined reference face shape, determining texture characteristic amounts for the transformed face image based on a texture model corresponding to the reference face shape, determining a shadow component for the face image in response to the determined texture characteristic amounts, determining a shadow component image having the same shape as the reference face shape, performing a second transformation of the shadow component image, and subtracting the shadow component image from the target image. The second transformation is the inverse of the first transformation.

For a fuller understanding of the nature and advantages of the present invention, reference should be made to the ensuing detailed description and accompanying drawings.

### BRIEF DESCRIPTION OF THE DRAWINGS

The invention is described below with reference to the accompanying drawings, wherein like numbers reference like elements.

FIG. 1 is an explanatory diagram schematically showing the configuration of a printer as an image processing apparatus in accordance with many embodiments.

FIG. 2 is a flowchart showing steps of an active appearance model (AAM) setting process, in accordance with many embodiments.

FIG. 3 is an explanatory diagram showing exemplary sample face images, in accordance with many embodiments.

FIG. 4 is an explanatory diagram illustrating the setting of characteristic points for a sample face image, in accordance with many embodiments.

FIG. 5 is an explanatory diagram showing exemplary coordinates of the characteristic points set in the sample face image of FIG. 4, in accordance with many embodiments.

FIGS. 6A and 6B are explanatory diagrams showing an exemplary average face shape, in accordance with many embodiments.

FIG. 7 is an explanatory diagram illustrating a warp method for transforming a sample face image into an average face shape image having the shape of a reference average face shape image, in accordance with many embodiments.

FIG. 8 is an explanatory diagram showing an example of an average face image, in accordance with many embodiments.

FIG. 9 is a flowchart showing steps of a face characteristic position specifying process in accordance with many embodiments.

FIG. 10 is an explanatory diagram illustrating the detection of a face area in a target image, in accordance with many embodiments.

FIG. 11 is a flowchart showing steps of an initial disposition determining process for characteristic points, in accordance with many embodiments.

FIGS. 12A and 12B are explanatory diagrams showing exemplary temporary dispositions of characteristic points in a target image, in accordance with many embodiments.

FIG. 13 is an explanatory diagram showing exemplary average shape images, in accordance with many embodiments.

FIG. 14 is an explanatory diagram showing an example of an initial disposition of characteristic points in a target image, in accordance with many embodiments.

FIG. 15 is a flowchart showing steps of an update process for the disposition of characteristic points, in accordance with many embodiments.

FIG. 16 is an explanatory diagram showing an exemplary result of a face characteristic position specifying process, in accordance with many embodiments.

FIG. 17 is a flowchart showing steps of an image correction process, in accordance with many embodiments.

FIG. 18 is an explanatory diagram illustrating an image correction process, in accordance with many embodiments.

FIG. 19 is a flowchart showing steps of an image correction process, in accordance with many embodiments.

### DETAILED DESCRIPTION

In the following description, various embodiments of the present invention are described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

### Image Processing Apparatus

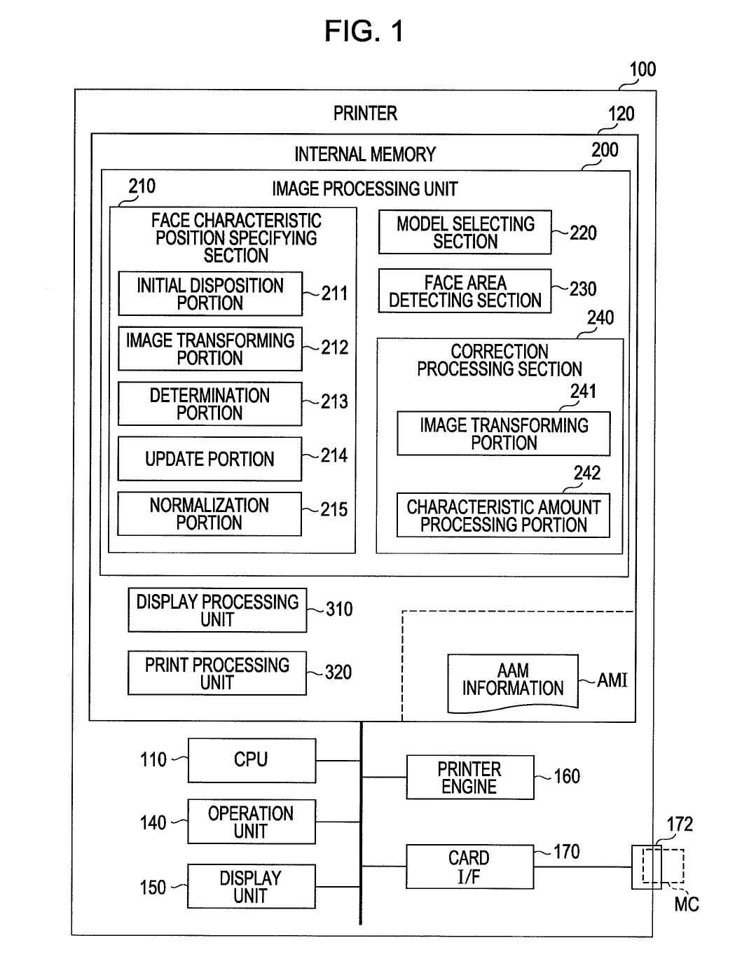

Referring now to the drawings, in which like reference numerals represent like parts throughout the several views, FIG. 1 is an explanatory diagram schematically showing the configuration of a printer 100 as an image processing apparatus, in accordance with many embodiments. The printer 100 can be a color ink jet printer corresponding to so-called direct printing in which an image is printed based on image data that is acquired from a memory card MC or the like. The printer 100 includes a CPU 110 that controls each unit of the printer 100, an internal memory 120 that includes a read-only memory (ROM) and a random-access memory (RAM), an operation unit 140 that can include buttons and/or a touch panel, a display unit 150 that includes a display (e.g., a liquid crystal display), a printer engine 160, and a card interface (card I/F) 170. In addition, the printer 100 can include an interface that is used for performing data communication with other devices (for example, a digital still camera or a personal computer). The constituent elements of the printer 100 are interconnected through a communication bus.

The printer engine 160 is a printing mechanism that performs a printing operation based on the print data. The card interface 170 is an interface that is used for exchanging data with a memory card MC inserted into a card slot 172. In many embodiments, an image file that includes target image data is stored in the memory card MC.

In the internal memory 120, an image processing unit 200, a display processing unit 310, and a print processing unit 320 are stored. The image processing unit 200 is a computer program for performing a face characteristic position specifying process under a predetermined operating system. The face characteristic position specifying process is a process for specifying (detecting) the positions of predetermined characteristic portions (for example, an eye area, a nose tip, or a face line) in a face image. The face correcting process is a process for decreasing a shadow component of a face image. The face characteristic position specifying process and the image correction process are described below in detail.

The image processing unit 200 includes a face characteristic position specifying section 210, a model selection section 220, a face area detecting section 230, and a correction processing section 240 as program modules. The face characteristic position specifying section 210 includes an initial disposition portion 211, an image transforming portion 212, a determination portion 213, an update portion 214, and a normalization portion 215. The correction processing section 240 includes an image transforming portion 241 and a characteristic amount processing portion 242. The image transforming portion 241 is also referred to herein as a first image transforming unit and a second image transforming unit. The functions of these sections and portions are described in detail in a description of the face characteristic position specifying process and the image correction process provided below.

The display processing unit 310 is a display driver that displays a process menu, a message, an image, or the like on the display unit 150 by controlling the display unit 150. The print processing unit 320 is a computer program that generates print data based on the image data and prints an image based on the print data by controlling the printer engine 160. The CPU 110 implements the functions of these units by reading out the above-described programs (the image processing unit 200, the display processing unit 310, and the print processing unit 320) from the internal memory 120 and executing the programs.

In addition, AAM information AMI is stored in the internal memory 120. The AAM information AMI is information that is set in advance in an AAM setting process described below and is referred to in the face characteristic position specifying process and the image correction process described below. The content of the AAM information AMI is described in detail in a description of the AAM setting process provided below.

### AAM Setting Process

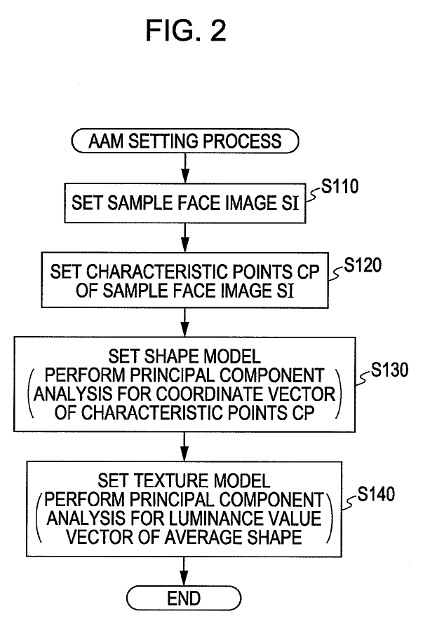

FIG. 2 is a flowchart showing steps of an AAM setting process in accordance with many embodiments. The AAM setting process is a process for setting a shape model and a texture model that are used in an image modeling technique called an active appearance model (AAM).

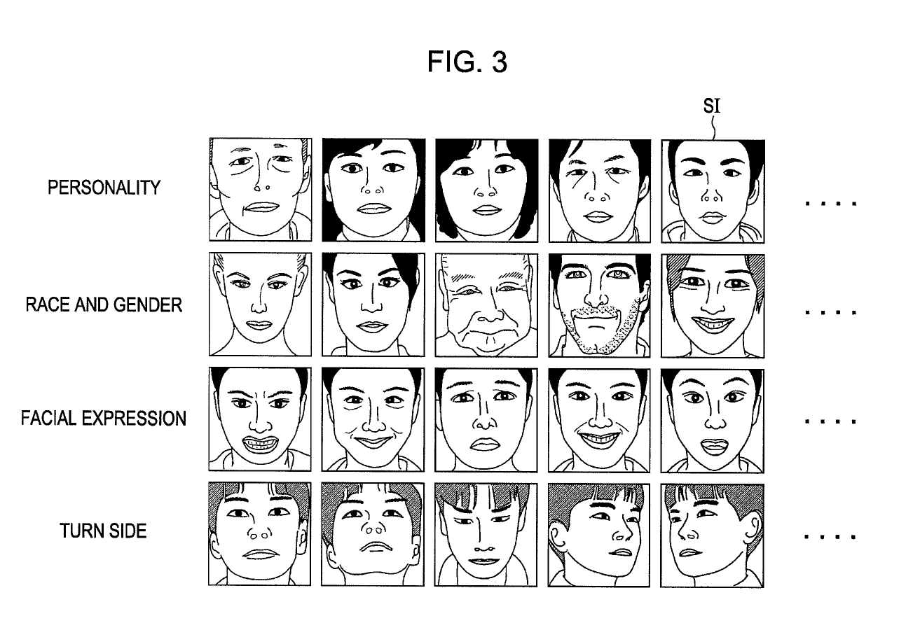

In Step S110, a plurality of images representing people's faces are set as sample face images Sᵢ. FIG. 3 is an explanatory diagram showing exemplary sample face images Sᵢ. As illustrated in FIG. 3, the sample face images Sᵢ can include images having different attributes for various attributes such as personality, race, gender, facial expression (anger, laughter, troubled, surprise, or the like), and a direction (front-side turn, upper-side turn, lower-side turn, right-side turn, left-side turn, or the like). When the sample face images Sᵢ are set in such a manner, a wide variety of face images can be modeled with high accuracy by using the AAM technique. Accordingly, the face characteristic position specifying process (described below) can be performed with high accuracy for a wide variety of face images. The sample face images Sᵢ are also referred herein to as face images for learning.

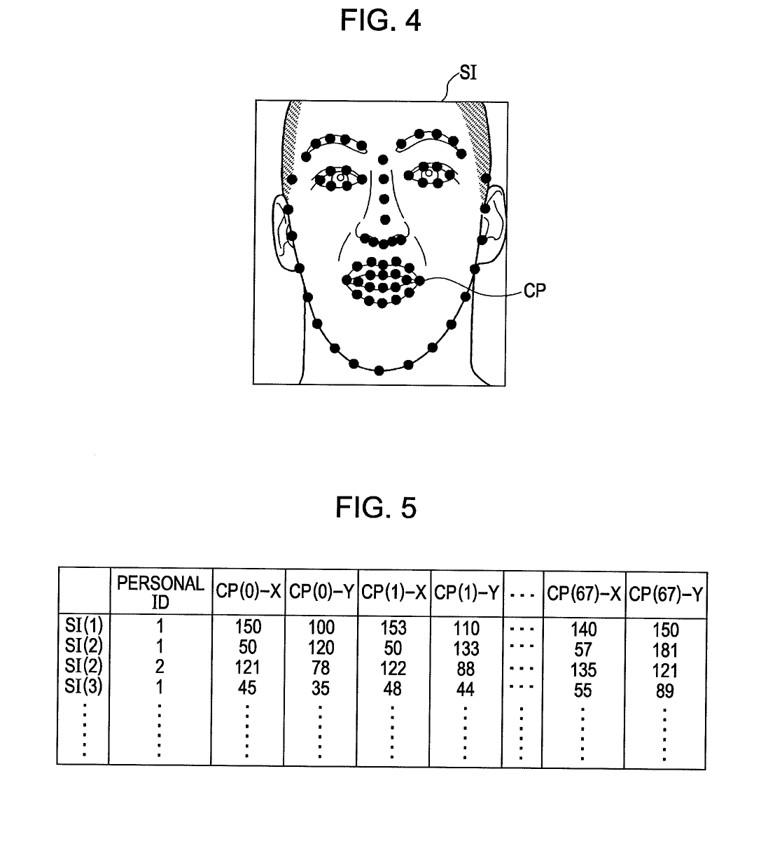

In Step S120 (FIG. 2), the characteristic points CP are set for each sample face image Sᵢ. FIG. 4 illustrates the setting the characteristic points CP for a sample face image Sᵢ. The characteristic points CP are points that represent the positions of predetermined characteristic portions of a face image. In many embodiments, 68 characteristic points are located on portions of a face image that include predetermined positions on the eyebrows (for example, end points, four-division points, or the like), predetermined positions on the contour of the eyes, predetermined positions on contours of the bridge of the nose and the wings of the nose, predetermined positions on the contours of upper and lower lips, and predetermined positions on the contour (face line) of the face. In other words, predetermined positions of facial organs (eyebrows, eyes, a nose, and a mouth) and the face line are set as the characteristic portions. As shown in FIG. 4, the characteristic points CP can be set (disposed) to the illustrated 68 positions to represent the characteristic portions of each sample face image S₁. The characteristic points can be designated, for example, by an operator of the image processing apparatus. The characteristic points CP correspond to the characteristic portions. Accordingly, the disposition of the characteristic points CP in a face image specifies the shape of the face.

The position of each characteristic point CP in a sample face image Sᵢ can be specified by coordinates. FIG. 5 is an explanatory diagram showing exemplary coordinates of the characteristic points CP set in the sample face image Sᵢ. In FIG. 5, Sᵢ(j) (j=1, 2, 3) represents each sample face image Sᵢ, and CP(k) (k=0, 1, 67) represents each characteristic point CP. In addition, CP(k)-X represents the X coordinate of the characteristic point CP(k), and CP(k)-Y represents the Y coordinate of the characteristic point CP(k). The coordinates of the characteristic point CP can be set by using a predetermined reference point (for example, a lower left point in an image) in a sample face image Sᵢ that has been normalized for face size, face tilt (a tilt within the image surface), and positions of the face in the X direction and in the Y direction. In addition, a case where a plurality of person's images is included in one sample face image Sᵢ is allowed (for example, two faces are included in a sample face image Sᵢ(2)), and the persons included in one sample face image Sᵢ are specified by personal IDs.

In Step S130 (FIG. 2), a shape model of the AAM is set. In particular, the face shape S that is specified by the positions of the characteristic points CP is modeled by the following Equation (1) by performing a principal component analysis for a coordinate vector (see FIG. 5) that includes the coordinates (X coordinates and Y coordinates) of 68 characteristic points CP in each sample face image Sᵢ. In addition, the shape model is also called a disposition model of characteristic points CP.

$$\begin{matrix}Equation ( 1 ) & \\ s = {s}_{0} + {\sum }_{i = 1}^{n} {p}_{i} {s}_{i} & ( 1 )\end{matrix}$$

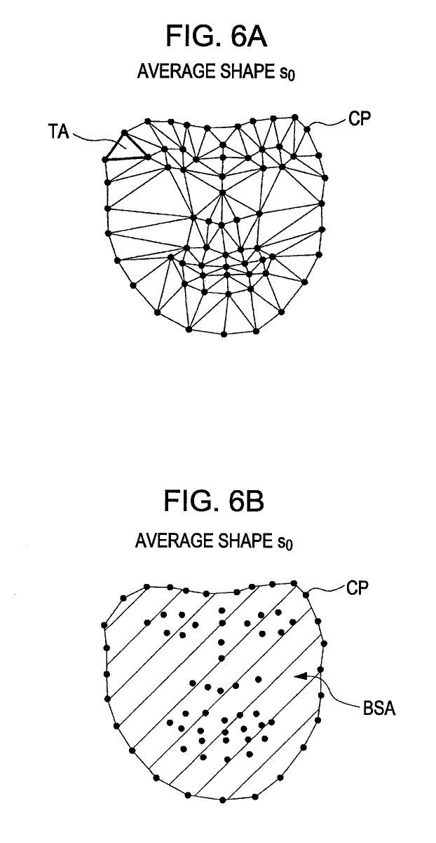

In the above-described Equation (1), s₀ is an average shape. FIGS. 6A and 6B are explanatory diagrams showing an example of the average shape s₀. In FIGS. 6A and 6B, the average shape s₀ is a model that represents an average face shape that is specified by average positions (average coordinates) of each characteristic points CP of the sample face images Sᵢ. An area (denoted by being hatched in FIG. 6B) surrounded by straight lines enclosing characteristic points CP (characteristic points CP corresponding to the face line, the eyebrows, and a region between the eyebrows; see FIG. 4) located on the outer periphery of the average shape s₀ is referred herein to as an “average shape area BSA”. The average shape s₀ is set such that, as shown in FIG. 6A, a plurality of triangle areas TA having the characteristic points CP as their vertexes divides the average shape area BSA into mesh shapes.

In the above-described Equation (1) representing a shape model, sᵢ is a shape vector, and pᵢ is a shape parameter that represents the weight of the shape vector sᵢ. The shape vector sᵢ can be a vector that represents characteristics of the face shape S. The shape vector sᵢ can be an eigenvector corresponding to an i-th principal vector that is acquired by performing principal component analysis. In other words, n eigenvectors that are set based on the accumulated contribution rates in the order of eigenvectors corresponding to principal components having greater variance can be used as the shape vectors sᵢ. In many embodiments, a first shape vector s₁ that corresponds to a first principal component having the greatest variance becomes a vector that is approximately correlated with the horizontal appearance of a face, and a second shape vector s₂ corresponding to a second principal component that has the second greatest variance is a vector that is approximately correlated with the vertical appearance of a face. In addition, a third shape vector s₃ corresponding to a third principal component having the third greatest variance becomes a vector that is approximately correlated with the aspect ratio of a face, and a fourth shape vector s₄ corresponding to a fourth principal component having the fourth greatest variance becomes a vector that is approximately correlated with the degree of opening of a mouth.

As shown in the above-described Equation (1), a face shape S that represents the disposition of the characteristic points CP is modeled as a sum of an average shape s₀ and a linear combination of n shape vectors sᵢ. By appropriately setting the shape parameters pᵢ for the shape model, the face shape S in a wide variety of images can be reproduced. In addition, the average shape s₀ and the shape vectors sᵢ that are set in the shape model setting step (Step S130 in FIG. 2) can be stored in the internal memory 120 as the AAM information AMI (FIG. 1). The average shape s₀ is also referred to herein as a reference shape, and a value acquired by multiplying a shape vector sᵢ by a shape vector pᵢ is also referred to herein as a shape characteristic amount.

In addition, in many embodiments, a plurality of the shape models corresponding to different face image sizes is set. In other words, a plurality of the average shapes s₀ and a plurality of sets of the shape vectors sᵢ corresponding to different face image sizes are set. The plurality of the shape models is set by normalizing the sample face images Sᵢ with respect to a plurality of levels of face sizes as target values and performing principal component analysis on the coordinate vectors configured by coordinates of the characteristic points CP of the sample face images Sᵢ.

In Step S140 (FIG. 2), a texture model of the AAM is set. In particular, first, image transformation (hereinafter, also referred to as “warp W”) is performed for each sample face image Sᵢ, so that the disposition of the characteristic points CP in the resulting transformed sample image Sᵢ is identical to that of the characteristic points CP in the average shape s₀.

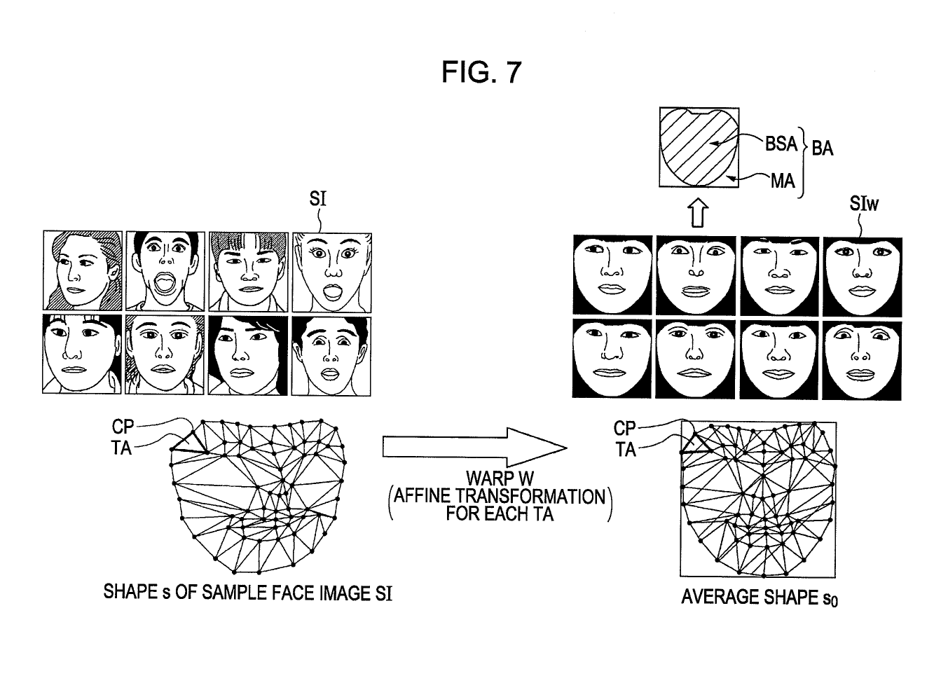

FIG. 7 is an explanatory diagram showing an example of a warp W method for a sample face image Sᵢ. For each sample face image Sᵢ, similar to the average shape s₀, a plurality of triangle areas TA that divides an area surrounded by the characteristic points CP located on the outer periphery into mesh shapes is set. The warp W is an affine transformation set for each of the plurality of triangle areas TA. In other words, in the warp W, an image of triangle areas TA in a sample face image Sᵢ is transformed into an image of corresponding triangle areas TA in the average shape s₀ by using the affine transformation method. By using the warp W, a transformed sample face image Sᵢ (hereinafter, referred to as a “sample face image SIw”) having the same disposition as that of the characteristic points CP of the average shape s₀ is generated.

In addition, each sample face image SIw is generated as an image in which an area (hereinafter, also referred to as a “mask area MA”) other than the average shape area BSA is masked by using the rectangular range including the average shape area BSA (denoted by being hatched in FIG. 7) as the outer periphery. An image area acquired by adding the average shape area BSA and the mask area MA is referred to as a reference area BA. As described above, since the plurality of the shape models (the average shapes s₀ and the plurality of sets of shape vectors sᵢ) corresponding to different face image sizes is set, the sample face image SIw is generated for each of the plurality of the shape models (average shape s₀). For example, each sample face image SIw is generated as an image of three-level sizes of 56 pixels×56 pixels, 256 pixels×256 pixels, and 500 pixels×500 pixels.

Next, the texture (also referred to as an “appearance”) A(x) of a face is modeled by using the following Equation (2) by performing principal component analysis for a luminance value vector that includes luminance values for each pixel group x of each sample face image SIw. In addition, the pixel group x is a set of pixels that are located in the average shape area BSA.

$$\begin{matrix}Equation ( 2 ) & \\ A ( x ) = {A}_{0} ( x ) + {\sum }_{i = 1}^{m} {λ}_{i} {A}_{i} ( x ) & ( 2 )\end{matrix}$$

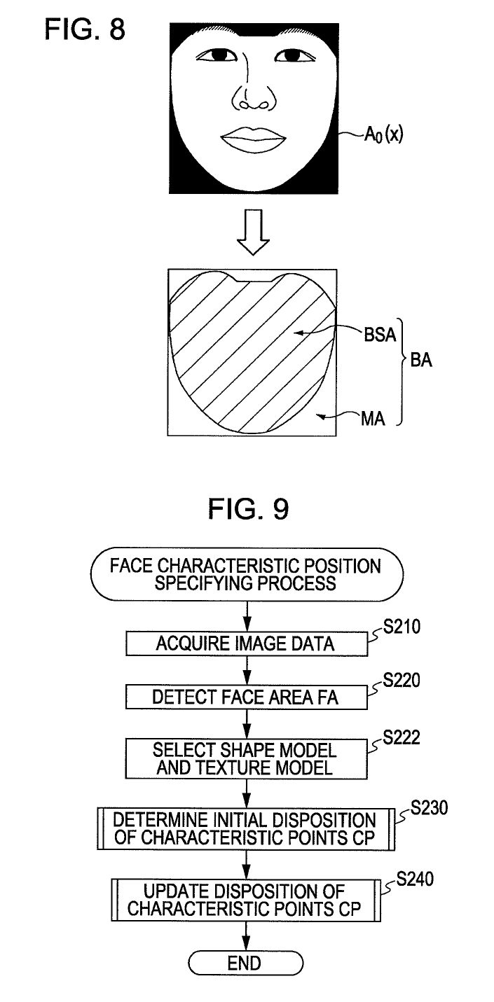

In the above-described Equation (2), A₀(x) is an average face image. FIG. 8 is an explanatory diagram showing an example of the average face image A₀(x). The average face image A₀(x) is an average face of sample face images SIw (see FIG. 7) after the warp W. In other words, the average face image A₀(x) is an image that is calculated by taking an average of pixel values (luminance values) of pixel groups x located within the average shape area BSA of the sample face images SIw. Accordingly, the average face image A₀(x) is a model that represents the texture of an average face in the average face shape. In addition, the average face image A₀(x), similar to the sample face image SIw, includes an average shape area BSA and a mask area MA. Also, for the average face image A₀(x), an image area acquired by adding the average face area BSA and the mask area MA together is referred to herein as a reference area BA.

In the above-described Equation (2) representing a texture model, Aᵢ(x) is a texture vector, and λᵢ are texture parameters that represents the weight of the texture vectors Aᵢ(x). The texture vectors Aᵢ(x) are vectors that represents the characteristics of the texture A(x) of a face. In many embodiments, a texture vector Aᵢ(x) is an eigenvector corresponding to an i-th principal component that is acquired by performing principal component analysis. In other words, m eigenvectors set based on the accumulated contribution rates in the order of the eigenvectors corresponding to principal components having greater variance are used as a texture vectors Aᵢ(x). In many embodiments, the first texture vector Aᵢ(x) corresponding to the first principal component having the greatest variance is a vector that is approximately correlated with a change in the color of a face (may be perceived as a difference in gender), and the second texture vector A₂(x) corresponding to the second principle component having the second greatest variance is a vector that is approximately correlated with a change in the shadow component (can be also perceived as a change in the position of a light source).

As shown in the above-described Equation (2), the face texture A(x) representing the outer appearance of a face can be modeled as a sum of the average face image A₀(x) and a linear combination of m texture vectors Aᵢ(x). By appropriately setting the texture parameters λᵢ in the texture model, the face textures A(x) for a wide variety of images can be reproduced. In many embodiments, the average face image A₀(x) and the texture vectors Aᵢ(x) that are set in the texture model setting step (Step S140 in FIG. 2) are stored in the internal memory 120 as the AAM information AMI (FIG. 1). The average image A₀(x) corresponds to a reference texture, and a value acquired by multiplying a texture vector Aᵢ(x) by a texture parameter λᵢ is also referred to herein as a predetermined texture characteristic amount.

In many embodiments, as described above, the plurality of the shape models corresponding to different face image sizes are set. Likewise, for the texture model, a plurality of texture models corresponding to different face image sizes are set. In other words, a plurality of average face images A₀(x) and a plurality of sets of texture parameters λᵢ corresponding to different face image sizes are set. The plurality of texture models are set by performing principal component analysis on a luminance value vector that includes luminance values for the pixel group x of the sample face images SIw that are generated for the plurality of shape models.

By performing the above-described AAM setting process (FIG. 2), a shape model that models a face shape and a texture model that models a face texture are set. By combining the shape model and the texture model that have been set, that is, by performing transformation (an inverse transformation of the warp W shown in FIG. 7) from the average shape s₀ into a shape S for the synthesized texture A(x), the shapes and the textures of a wide variety of face images can be reproduced.

Face characteristic Position Specifying Process

FIG. 9 is a flowchart showing steps of a face characteristic position specifying process, in accordance with many embodiments. The face characteristic position specifying process is a process for specifying the positions of characteristic portions of a face included in a target image by determining the disposition of the characteristic points CP in the target image by using the AAM technique. As described above, in many embodiments, a total of 68 predetermined positions of a person's facial organs (the eyebrows, the eyes, the nose, and the mouth) and the contour of the face are set as the characteristic portions (see FIG. 4) in the AAM setting process (FIG. 2). Accordingly, the disposition of 68 characteristic points CP that represent predetermined positions of the person's facial organs and the contour of the face is determined.

When the disposition of the characteristic points CP in the target image is determined by performing the face characteristic position specifying process, the shapes and the positions of the facial organs of a person and the contour shape of the face that are included in a target image can be specified. Accordingly, the result of the face characteristic position specifying process can be used in an expression determination process for detecting a face image having a specific expression (for example, a smiling face or a face with closed eyes), a face-turn direction determining process for detecting a face image positioned in a specific direction (for example, a direction turning to the right side or a direction turning to the lower side), a face transformation process for transforming the shape of a face, or the like.

In Step S210 (FIG. 9), the image processing unit 200 (FIG. 1) acquires image data representing a target image that becomes a target for the face characteristic position specifying process. For example, when the memory card MC is inserted into the card slot 172 of the printer 100, a thumbnail image of the image file that is stored in the memory card MC can be displayed on the display unit 150. In many embodiments, a user selects one or a plurality of images that becomes the processing target via the operation unit 140 while referring to the displayed thumbnail image. The image processing unit 200 acquires the image file that includes the image data corresponding to one or the plurality of images that has been selected from the memory card MC and stores the image file in a predetermined area of the internal memory 120. The acquired image data is referred to herein as target image data, and an image represented by the target image data is referred to herein as a target image OI.

In Step S220 (FIG. 9), the face area detecting section 230 (FIG. 1) detects a predetermined area corresponding to a face image in the target image OI as a face area FA. The detection of the face area FA can be performed by using a known face detection technique. Such known face detection techniques include, for example, a technique using pattern matching, a technique using extraction of a skin-color area, a technique using learning data that is set by learning (for example, learning using a neural network, learning using boosting, learning using a support vector machine, or the like) using sample face images, and the like.

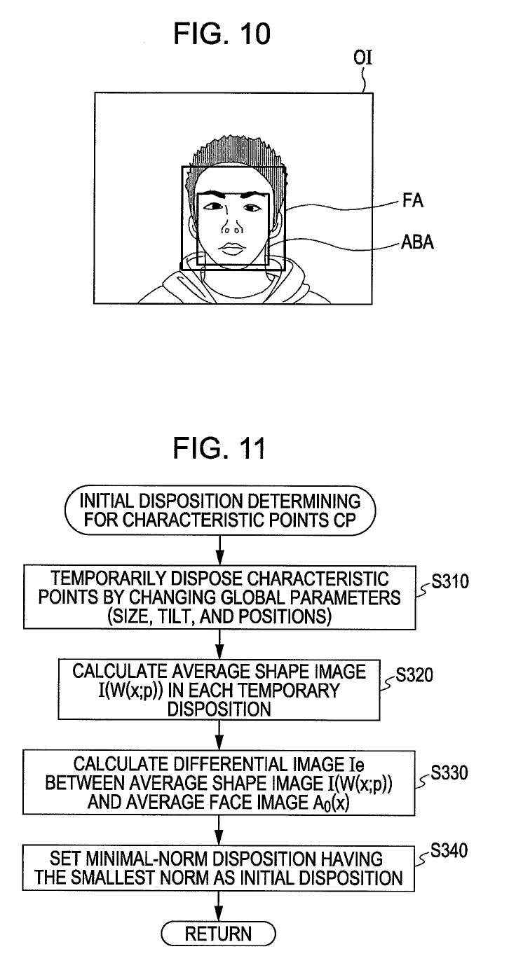

FIG. 10 is an explanatory diagram illustrating detection of a face area FA in the target image OI. In FIG. 10, a face area FA detected from the target image OI is shown. In many embodiments, a face detection technique is used that detects a rectangle area that approximately includes from the forehead to the chin in the vertical direction of the face and approximately includes the outer sides of both the ears in the horizontal direction as the face area FA.

In addition, an assumed reference area ABA shown in FIG. 10 is an area that is assumed to be in correspondence with the reference area BA (see FIG. 8) that is the entire area of the average face image A₀(x). The assumed reference area ABA is set as an area, which has predetermined relationship with the face area FA for the size, the tilt, and the positions located in the upper, lower, left and right sides, based on the detected face area FA. The predetermined relationship between the face area FA and the assumed reference area ABA is set in advance in consideration of the characteristics (the range of a face detected as the face area FA) of the face detection technique used in detecting the face area FA such that the assumed reference area ABA corresponds to the reference area BA for a case where the face represented in the face area FA is an average face.

When the face area FA is not detected from the target image OI in Step S220 (FIG. 9), it is determined that a face image is not included in the target image OI. Accordingly, the face characteristic position specifying process is completed, or the face area FA detection process is performed again.

In Step S222 (FIG. 9), the model selection section 220 (FIG. 1) acquires the face image size of the target image OI and selects one shape model and one texture model from the plurality of shape models and the plurality of texture models corresponding to different face image sizes based on the acquired face image size. In particular, the model selection section 220 acquires the size of the set assumed reference area ABA as the face image size and selects a shape model and a texture model corresponding to a size closest to the size of the assumed reference area ABA. Then, in a process performed thereafter in the face characteristic position specifying process (FIG. 9), the shape model and the texture model that have been selected are used.

In Step S230 (FIG. 9), the face characteristic position specifying section 210 (FIG. 1) determines the initial disposition of the characteristic points CP in the target image OI. FIG. 11 is a flowchart showing steps of an initial disposition determining process for the characteristic points CP, in accordance with many embodiments. In Step S310 of the initial disposition determining process for the characteristic points CP, the initial disposition portion 211 (FIG. 1) sets a temporary disposition of the characteristic points CP on the target image OI by variously changing the values of the size, the tilt, and the positions (the position in the vertical direction and the position in the horizontal direction) as the global parameters.

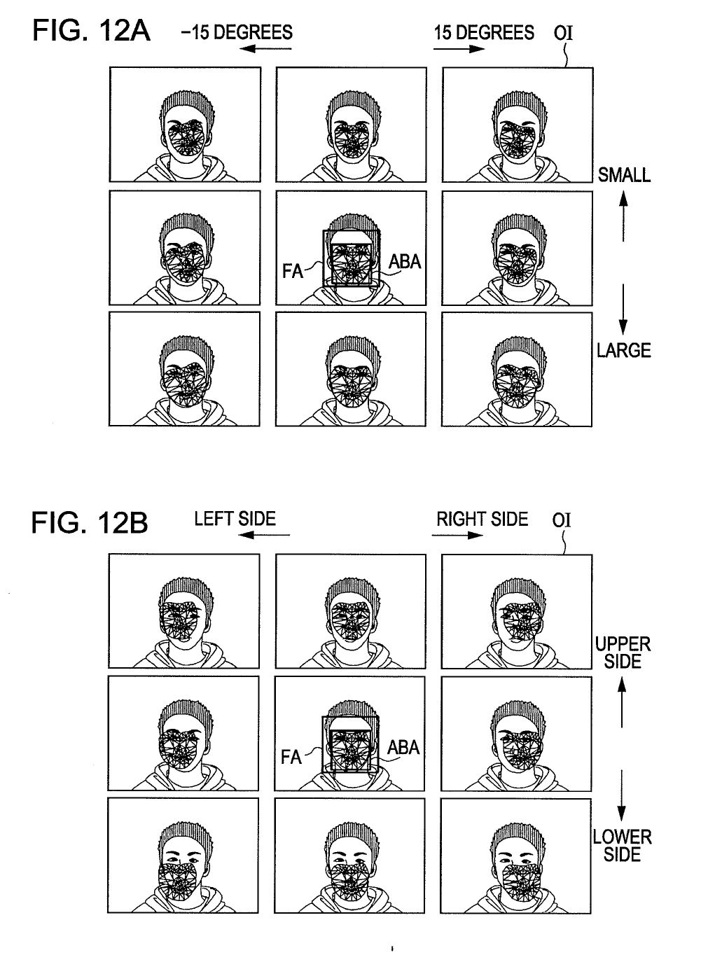

FIGS. 12A and 12B are explanatory diagrams showing exemplary temporary dispositions of the characteristic points CP in the target image OI. In FIGS. 12A and 12B, the temporary dispositions of the characteristic points CP in the target image OI are represented by meshes. In many embodiments, each intersection of the meshes is a characteristic point CP. The initial disposition portion 211, as shown in FIGS. 12A and 12B on the center, sets the temporary disposition (hereinafter, also referred to as “reference temporary disposition”) specified by the characteristic points CP of the average face image A₀(x) for a case where the average face image A₀(x) (FIG. 8) is overlapped with the assumed reference area ABA (see FIG. 10) of the target image OI.

The initial disposition portion 211 sets temporary disposition by variously changing the values of the global parameters for the reference temporary disposition. The changing of the global parameters (the size, the tilt, the positions in the vertical direction, and the positions in the horizontal direction) corresponds to performing enlargement or reduction, a change in the tilt, and parallel movement of the meshes that specify the temporary disposition of the characteristic points CP. Accordingly, the initial disposition portion 211, as shown in FIG. 12A, sets temporary disposition (shown below or above the reference temporary disposition) specified by meshes acquired by enlarging or reducing the meshes of the reference temporary disposition at a predetermined scaling factor and temporary disposition (shown on the right side or the left side of the reference temporary disposition) that is specified by meshes acquired by changing the tilt of the meshes of the reference temporary disposition by a predetermined angle in the clockwise direction or the counterclockwise direction. In addition, the initial disposition portion 211 also sets temporary disposition (shown on the upper left side, the lower left side, the upper right side, and the lower right side of the reference temporary disposition) specified by meshes acquired by performing a transformation combining enlargement or reduction and a change in the tilt of the meshes of the reference temporary disposition.

In addition, as shown in FIG. 12B, the initial disposition portion 211 sets temporary disposition (shown above or below the reference temporary disposition) that is specified by meshes acquired by performing parallel movement of the meshes of the reference temporary disposition by a predetermined amount to the upper side or the lower side and temporary disposition (shown on the left side and the right side of the reference temporary disposition) that is specified by meshes acquired by performing parallel movement of the reference temporary disposition to the left or right side. In addition, the initial disposition portion 211 sets temporary disposition (shown on the upper left side, the lower left side, the upper right side, and the lower right side of the reference temporary disposition) that is specified by meshes acquired by performing the transformation combining the parallel movement to the upper or lower side and the left or right side for the meshes of the reference temporary disposition.

In addition, the initial disposition portion 211 also sets temporary disposition that is specified by meshes, shown in FIG. 12B, acquired by performing parallel movement to the upper or lower side and to the left or right side for the meshes of eight temporary dispositions other than the reference temporary disposition shown in FIG. 12A. Accordingly, in many embodiments, a total of 81 types of the temporary dispositions are used and include the reference temporary disposition and 80 types of temporary dispositions that are set by performing 80 (=3×3×3×3−1) types of transformations corresponding to combinations of three-level values of four global parameters (the size, the tilt, the positions in the vertical direction, and the positions in the horizontal direction) for meshes of the reference temporary disposition.

In many embodiments, the correspondence relationship between the average face image A₀(x) of the reference temporary disposition and the assumed reference area ABA of the target image OI is also referred to herein as “reference correspondence relationship”. The setting of the temporary disposition can be described to be implemented by setting correspondence relationship (hereinafter, also referred to as “transformed correspondence relationship”) between the average face image A₀(x) and the target image OI after the above-described 80 types of transformations for either the average face image A₀(x) or the target image OI with reference to the reference correspondence relationship and by using the disposition of the characteristic points CP of the average face image A₀(x) according to the reference correspondence relationship and the transformed correspondence relationship as the temporary disposition of the characteristic points CP in the target image OI.

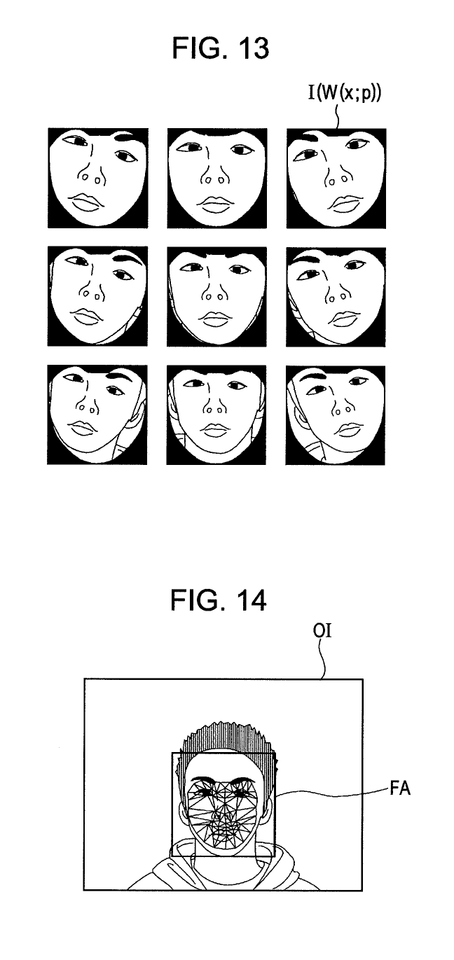

In Step S320 (FIG. 11), the image transforming portion 212 (FIG. 1) calculates the average shape image I(W(x;p)) corresponding to each temporary disposition that has been set. FIG. 13 is an explanatory diagram showing exemplary average shape images I(W(x;p)). Each average shape image I(W(x;p)) is a face image that has the average shape s₀. Each average shape image I(W(x;p)) is calculated by performing a transformation of a portion of the input image so that the disposition of the characteristic points CP in the transformed image is identical to that of the characteristic points CP in the average shape s₀.

The transformation for calculating the average shape image I(W(x;p)), similar to the transformation (see FIG. 7) for calculating the sample face image SIw, is performed by a warp W that is an affine transformation set for each triangle area TA. In particular, the average shape image I(W(x;p)) is calculated by specifying the average shape area BSA (an area surrounded by the characteristic points CP that are located on the outer periphery; see FIGS. 6A and 6B) in the target image OI by the characteristic points CP (see FIGS. 12A and 12B) disposed on the target image OI and performing the affine transformation for each triangle area TA of the average shape area BSA. In many embodiments, the average shape image I(W(x;p)), similar to the average face image A₀(x), includes an average shape area BSA and a mask area MA and is acquired as an image having the same size as that of the average face image A₀(x). In FIG. 13, nine exemplary average shape images I(W(x;p)) corresponding to nine dispositions shown in FIG. 12A are shown.

In addition, as described above, a pixel group x is a set of pixels located in the average shape area BSA of the average shape s₀. The pixel group of an image (the average shape area BSA of the target image OI), for which the warp W has not been performed, corresponding to the pixel group x of an image (a face image having the average shape s₀) for which the warp W has been performed is denoted as W(x;p). The average shape image is an image that includes luminance values for each pixel group W(x;p) in the average shape area BSA of the target image OI. Thus, the average shape image is denoted by I(W(x;p)).

In Step S330 (FIG. 11), the initial disposition portion 211 (FIG. 1) calculates a differential image Ie between each average shape image I(W(x;p)) and the average face image A₀(x). Since 81 types of the temporary dispositions of the characteristic points CP are set, 81 average shape images I(W(x;p)) are set. Accordingly, the initial disposition portion 211 calculates 81 differential images Ie.

In Step S340 (FIG. 11), the initial disposition portion 211 (FIG. 1) calculates norms of the differential images Ie and sets a temporary disposition (hereinafter, also referred to as a “minimal norm temporary disposition”) corresponding to the differential image Ie having the smallest value of the norm as the initial disposition of the characteristic points CP in the target image OI. The minimal-norm temporary disposition is a temporary disposition corresponding to the average shape image I(W(x;p)) that has a lowest a difference from the (closest to or most similar to) average face image A₀(x). In addition, the selection of the minimal-norm temporary disposition is a parallel expression of selecting a correspondence relationship that has a smallest difference between the average shape image I(W(x;p)) after the normalization process and the average face image A₀(x) from among the above-described correspondence relationship and 80 types of the transformed correspondence relationships and selecting a temporary disposition corresponding to the selected correspondence relationship. By performing the initial disposition process for the characteristic points CP, approximate values of the global parameters, which define the overall size, the tilt, and the positions (the position in the vertical direction and the position in the horizontal direction) of the disposition of the characteristic points CP in the target image OI are set.

FIG. 14 is an explanatory diagram showing an example of the initial disposition of the characteristic points CP in the target image OI. In FIG. 14, the initial disposition of the characteristic points CP determined for the target image OI is represented by meshes. In many embodiments, intersections of the meshes are the characteristic points CP.

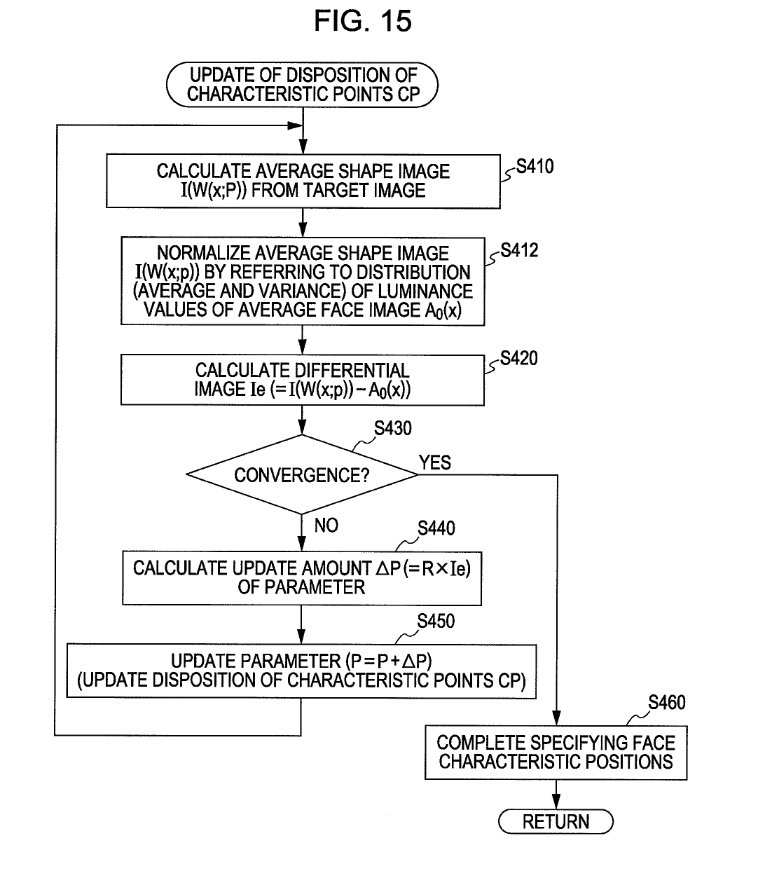

When the initial disposition determining process (Step S230 shown in FIG. 9) for the characteristic points CP is completed, the face characteristic position specifying section 210 (FIG. 1) updates the characteristic points CP of the target image OI (Step S240). FIG. 15 is a flowchart showing steps of an update process for the disposition of the characteristic points CP, in accordance with many embodiments.

In Step S410 of the update process (FIG. 15) for the disposition of the characteristic points CP, the image transforming portion 212 (FIG. 1) calculates an average shape image I(W(x;p)) from the target image OI. The average shape image I(W(x;p)) is a face image having the average shape s₀. The average shape image I(W(x;p)) is calculated by performing a transformation to part of the target image so that the disposition of the characteristic points CP in the resulting transformed image is identical to the disposition (see FIGS. 6A and 6B) of the characteristic points CP in the average shape s₀.

The transformation for calculating the average shape image I(W(x;p)), similar to the transformation (see FIG. 7) for calculating the sample face image SIw, is performed by a warp W that is an affine transformation set for each triangle area TA. In particular, the average shape image I(W(x;p)) is calculated by specifying the average shape area BSA (an area surrounded by the characteristic points CP that are located on the outer periphery; see FIGS. 6A and 6B) of the target image OI by the characteristic points CP (see FIG. 14) disposed on the target image OI and performing the affine transformation for each triangle area TA of the average shape area BSA. In many embodiments, the average shape image I(W(x;p)), similar to the average face image A₀(x), includes an average shape area BSA and a mask area MA and is calculated as an image having the same size as that of the average face image A₀(x).

In Step S412 (FIG. 15), the normalization portion 215 (FIG. 1) normalizes the average shape image I(W(x;p)) by referring to an index value that represents the distribution of luminance values of the average face image A₀(x). In many embodiments, information representing an average value and a variance value as the index value that represents the distribution of the luminance values in the average shape area BSA (see FIG. 8) of the average face image A₀(x) is included in the AAM information AMI. The normalization portion 215 calculates the average value and the variance value of the luminance values in the average shape area BSA of the average shape image I(W(x;p)). Then, the normalization portion 215 performs image transformation (normalization process) for the average shape area BSA of the average shape image I(W(x;p)) such that the average value and the variance value, which have been calculated, are identical to those of the luminance values of the average face image A₀(x).

In Step S420 (FIG. 15), the face characteristic position specifying section 210 (FIG. 1) calculates a differential image Ie between the average shape image I(W(x;p)) after the normalization process and the average face image A₀(x). In Step S430, the determination portion 213 (FIG. 1) determines whether the disposition update process for the characteristic points CP converges based on the differential image Ie. The determination portion 213 calculates a norm of the differential image Ie. Then, in a case where the value of the norm is less than a threshold value set in advance, the determination portion 213 determines convergence. On the other hand, in a case where the value of the norm is equal to or more than the threshold value, the determination portion 213 determines no convergence. The norm of the differential image Ie is an index value that represents the degree of a difference between the average shape image I(W(x;p)) and the average face image A₀(x).

In addition, in the determination of convergence in Step S430, the determination portion 213 can be configured to determine convergence for a case where the calculated value of the norm of the differential image Ie is less than a value calculated in Step S430 of the previous time and to determine no convergence for a case where the calculated value of the norm of the differential image Ie is equal to or more than the previous value. The determination portion 213 can also be configured to determine convergence by combining the determination on the basis of the threshold value and the determination on the basis of comparison with the previous value. For example, the determination portion 213 can be configured to determine convergence only for cases where the calculated value of the norm is less than the threshold value and is less than the previous value and to determine no convergence for other cases.

When no convergence is determined in the convergence determination of Step S430, the update portion 214 (FIG. 1) calculates the update amount ΔP of the parameters (Step S440). The update amount ΔP of the parameters represents the amount of change in the values of the four global parameters (the overall size, the tilt, the X-direction position, and the Y-direction position) and n shape parameters pᵢ (see Equation (1)). In addition, right after the initial disposition of the characteristic points CP, the global parameters are set to values determined in the initial disposition determining process (FIG. 11) for the characteristic points CP. In addition, a difference between the initial disposition of the characteristic points CP and the characteristic points CP of the average shape s₀ is limited to differences in the overall size, the tilt, and the positions. Accordingly, all the values of the shape parameters pᵢ of the shape model are zero.

In many embodiments, the update amount ΔP of the parameters is calculated by using the following Equation (3). In other words, the update amount ΔP of the parameters is the product of an update matrix R and the difference image Ie.

Equation (3)

ΔP=R×Ie (3)

The update matrix R represented in Equation (3) is a matrix of M rows×N columns that is set by learning in advance for calculating the update amount ΔP of the parameters based on the differential image Ie and is stored in the internal memory 120 as the AAM information AMI (FIG. 1). In many embodiments, the number M of the rows of the update matrix R is identical to a sum (4+n) of the number (4) of the global parameters and the number (n) of the shape parameters pᵢ, and the number N of the columns is identical to the number within the average shape area BSA of the average face image A₀(x) (FIG. 8). In many embodiments, the update matrix R is calculated by using the following Equations (4) and (5).

$$\begin{matrix}Equation ( 4 ) & \\ R = {H}^{- 1} \sum {[ ∇ {A}_{0} \frac{\partial W}{\partial P} ]}^{T} & ( 4 ) \\ Equation ( 5 ) & \\ H = \sum {[ ∇ {A}_{0} \frac{\partial W}{\partial P} ]}^{T} [ ∇ {A}_{0} \frac{\partial W}{\partial P} ] & ( 5 )\end{matrix}$$

Equations (4) and (5), as well as active models in general, are described in Matthews and Baker, “Active Appearance Models Revisited,” tech. report CMU-RI-TR-03-02, Robotics Institute, Carnegie Mellon University, April 2003, the full disclosure of which is hereby incorporated by reference.

In Step S450 (FIG. 15), the update portion 214 (FIG. 1) updates the parameters (four global parameters and n shape parameters pᵢ) based on the calculated update amount ΔP of the parameters. Accordingly, the disposition of the characteristic points CP of the target image OI is updated. After update of the parameters is performed in Step S450, again, the average shape image I(W(x;p)) is calculated from the target image OI for which the disposition of the characteristic points CP has been updated (Step S410), the differential image Ie is calculated (Step S420), and a convergence determination is made based on the differential image Ie (Step S430). In a case where no convergence is determined in the repeated convergence determination, additionally, the update amount ΔP of the parameters is calculated based on the differential image Ie (Step S440), and the disposition update of the characteristic points CP by updating the parameters is performed (Step S450).

When the process from Step S410 to Step S450 in FIG. 15 is repeatedly performed, the positions of the characteristic points CP corresponding to the characteristic portions of the target image OI approach the positions (correct positions) of actual characteristic portions as a whole. Then, the convergence is determined in the convergence determination (Step S430) at a time point. When the convergence is determined in the convergence determination, the face characteristic position specifying process is completed (Step S460). The disposition of the characteristic points CP specified by the values of the global parameters and the shape parameters pᵢ that are set at that moment is determined to be the final disposition of the characteristic points CP of the target image OI.

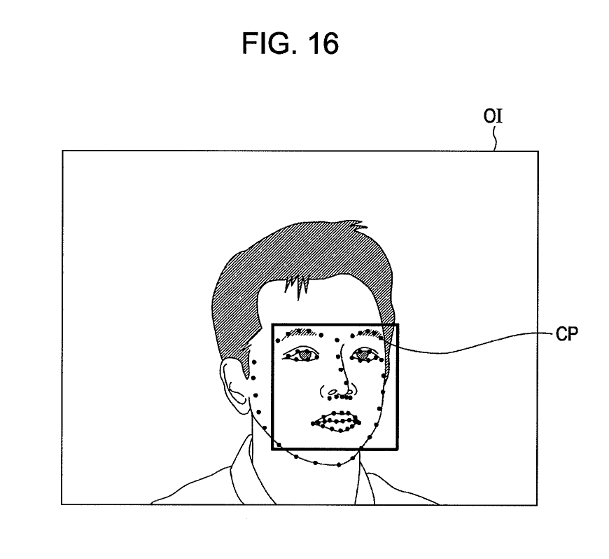

FIG. 16 is an explanatory diagram showing an exemplary result of a face characteristic position specifying process. In FIG. 16, the disposition of the characteristic points CP that is finally determined for the target image OI is shown. By disposing the characteristic points CP, the positions of the characteristic portions (person's facial organs, the eyebrows, the eyes, the nose, and the mouth) and predetermined positions in the contour of a face) of the target image OI are specified. Accordingly, the shapes and the positions of the person's facial organs and the contour and the shape of the face of the target image OI can be specified.

As described above, in the face characteristic specifying process, the initial disposition of the characteristic points CP in the target image OI is determined. Thereafter, the disposition of the characteristic points CP in the target image OI is updated based on the result of comparing the average shape image I(W(x;p)) calculated from the target image OI with the average face image A₀(x). In other words, in the initial disposition determining process for the characteristic points CP (FIG. 11), the approximate values of global parameters that define the overall size, the tilt, and the positions (the position in the vertical direction and the position in the horizontal direction) of the disposition of the characteristic points CP are determined. In the update process (FIG. 15) for the characteristic points CP performed thereafter, the disposition of the characteristic points CP is updated in accordance with the update of the parameters performed based on the differential image Ie, and the final disposition of the characteristic points CP in the target image OI is determined. As described above, by determining the approximate values of the global parameters that have a great variance (large dispersion) in the overall disposition of the characteristic points CP in the initial disposition determining process, first, the efficiency, the speed, and the accuracy of the face characteristic position specifying process may be improved (final determination on the disposition of the characteristic points CP not on the basis of a so-called local optimized solution but on the basis of a global optimized solution).

In addition, in the update process (FIG. 15) for the disposition of the characteristic points CP, before calculating the differential image Ie (Step S420 shown in FIG. 15) between the average shape image I(W(x;p)) calculated from the target image OI and the average face image A₀(x), the image transformation (normalization process) for the average shape image I(W(x;p)) is performed such that the average values and the variance values of the luminance values of the average shape area BSA of the average shape image I(W(x;p)) and the average shape area BSA of the average face image A₀(x) are identical to each other (Step S412). Accordingly, the influence of the characteristics of the distribution of the luminance values of the individual target image OI on the differential image Ie is suppressed, whereby the accuracy of the convergence determination (Step S430) on the basis of the differential image Ie may be improved. Furthermore, the accuracy of the face characteristic position specifying process may be improved. In addition, in the convergence determination, as described above, by performing a determination by using an absolute threshold value, the determination may be made with high accuracy. Accordingly, for example, compared to a case where the convergence determination is made by comparing the value of the norm of the differential image Ie with a previous value, high speed processing may be achieved.

Image correction Process

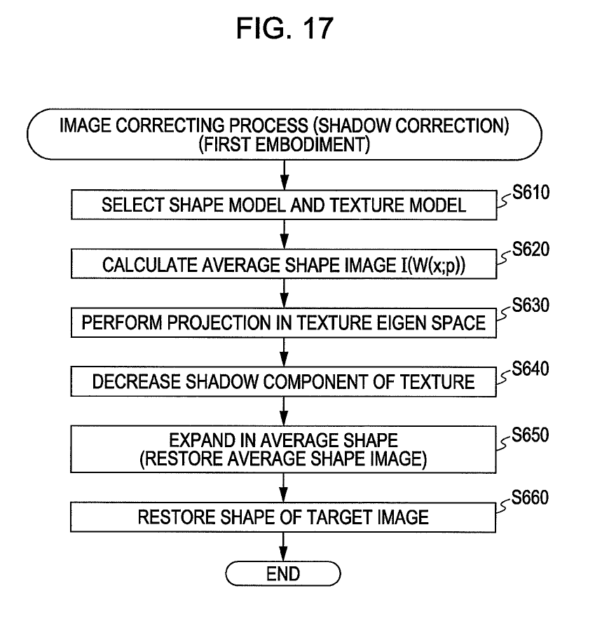

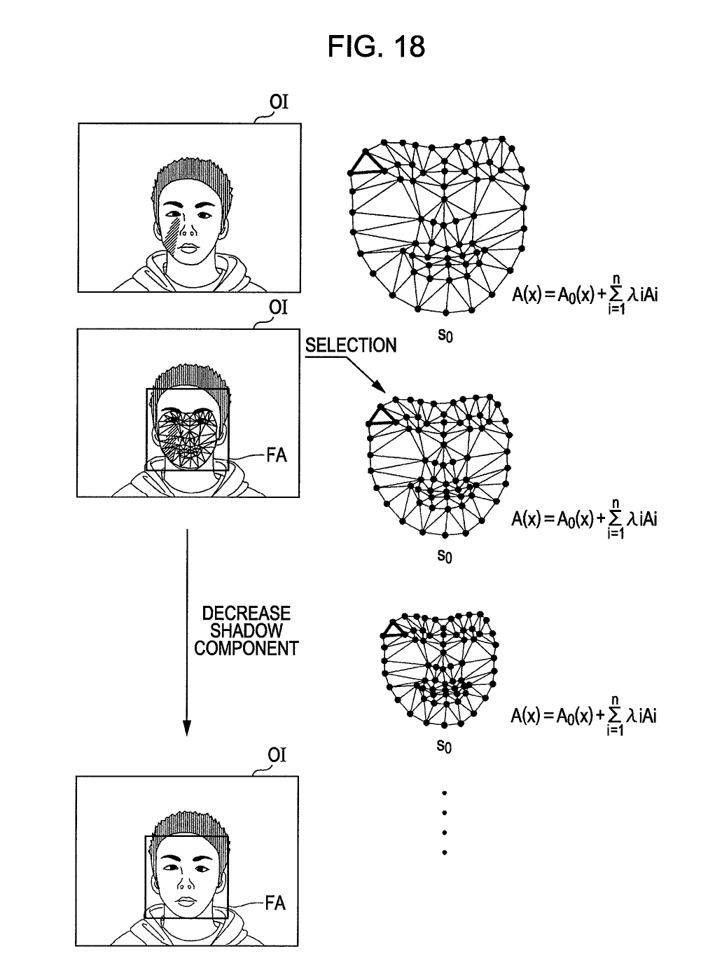

FIG. 17 is a flowchart showing steps of an image correction process, in accordance with many embodiments. FIG. 18 is an explanatory diagram illustrating the image correction process of FIG. 17. The image correction process is a process (shadow correction) for decreasing a shadow component of a face image to a desired level for the target image OI of which the disposition of the characteristic points CP is determined by the above-described face characteristic position specifying process (FIG. 9). By performing the image correction process (shadow correction), the influence of oblique light, backlight, or a partial shadow on a face portion of the target image OI can be reduced or completely eliminated. On the upper left side in FIG. 18, an example of the target image OI that includes a face image in which shadow is on a part of a face and an example (intersections of meshes are the characteristic points CP) of a disposition of the characteristic points CP specified in the target image OI are shown.

In Step S610 (FIG. 17), the model selection section 220 (FIG. 1) acquires the face image size in the target image OI and selects one shape model and one texture model out of a plurality of shape models and a plurality of texture models that are set in correspondence with different face image sizes based on the acquired face image size. The selecting of the shape model and the texture model is performed in the same manner as in Step S222 of the above-described face characteristic position specifying process (FIG. 9). In other words, the model selection section 220 acquires the size of an average shape area BSA as the face image size by determining the average shape area BSA (an area surrounded by the characteristic points CP located on the outer periphery; see FIGS. 6A and 6B) of the target image OI based on the disposition of the characteristic points CP. Then, the model selection section 220 selects a shape model and a texture model corresponding to a face image size that is the closest to the acquired face image size. FIG. 18 illustrates, in part, the selection of one shape model (average shape s₀) and one texture model (texture A(x)) based on the detected face image size from among the plurality of shape models and the plurality of texture models corresponding to different face image sizes. In the process of the image correction process (FIG. 17) performed thereafter, the shape model and the texture model that have been selected are used.

In Step S620 (FIG. 17), the image transforming portion 241 (FIG. 1) calculates the average shape image I(W(x;p)) from the target image OI. The calculating of the average shape image I(W(x;p)) is performed in the same manner as in the calculating of the average shape image I(W(x;p)) in Step S410 of the above-described update process (FIG. 15) for the characteristic points CP. In other words, the average shape image I(W(x;p)) is calculated by performing a transformation of part of the target image so that the disposition of the characteristic points CP in the resulting transformed target image matches the disposition (see FIGS. 6A and 6B) of the characteristic points CP in the average shape s₀ for the above-described average shape area BSA of the target image OI. The transformation used for calculating the average shape image I(W(x;p)) is performed by a warp W that is an affine transformation set for each triangle area TA. In many embodiments, the average shape image I(W(x;p)), similar to the average face image A₀(x) (see FIG. 8), includes an average shape area BSA and a mask area MA. In addition, the average shape image I(W(x;p)) is calculated as an image having the same size as the average shape s₀ of the selected shape model. The transformation for calculating the average shape image I(W(x;p)) from the target image OI is also referred to herein as a first transformation.

In Step S630 (FIG. 17), the characteristic amount processing portion 242 (FIG. 1) calculates the texture A(x) (see the above-described Equation (2)) by projecting the average shape image I(W(x;p)) into a texture eigenspace. The calculating of the texture A(x) by projecting the average shape image into the texture eigenspace is performed by using the texture model selected in 5610.

In Step S640 (FIG. 17), the characteristic amount processing portion 242 (FIG. 1) decreases the shadow component of the texture A(x). As described above, in many embodiments, the second texture vector A₂(x) corresponding to the second principal component of the texture A(x) is a vector that is approximately correlated with a change in the shadow component (it can be also perceived as a change in the position of the light source). In other words, a value acquired by multiplying the second texture vector A₂(x) by the texture parameter λ₂ substantially corresponds to the shadow component of the texture A(x). Accordingly, the characteristic amount processing portion 242 decreases the shadow component of the texture A(x) by changing the texture parameter λ₂ of the second texture vector A₂(x). For example, by changing the value of the texture parameter λ₂ to zero, the shadow component of the texture A(x) is eliminated. In addition, the degree of the decrease in the shadow component can be set based on the user's designation. Alternatively, the degree of the decrease in the shadow component can be set to be a predetermined degree in advance.

In Step S650 (FIG. 17), the characteristic amount processing portion 242 (FIG. 1) restores the average shape image I(W(x;p)) by expanding the texture A(x), of which the shadow component has decreased, in the average shape s₀. In Step S660, the image transforming portion 241 restores the restored average shape image I(W(x;p)) to the shape of the target image OI. The restoring of the average shape image in Step S660 is an inverse transformation of the transformation (first transformation) used for calculating the average shape image I(W(x;p)) in Step S620. By performing the process described above, the shadow component of the face image in the target image OI decreases to a desired level (see the lower left side in FIG. 18).

As described above, the shadow component of a face image included in a target image OI can be decreased to a desired level. In many embodiments, the face image size (the size of the average shape area BSA) in the target image OI is acquired, and a shape model (average shape s₀) and a texture model (texture A(x)) corresponding to a size closest to the acquired face image size are selected. Then, by using the shape model and the texture model that have been selected, steps of the calculating of the average shape image I(W(x;p)) (Step S620 shown in FIG. 17), the projecting into the texture eigenspace (Step S630), the expanding into the average shape s₀ (Step S650), and the restoring to the shape of the target image OI (Step S660) are performed. As a result, the resulting image quality from a process for changing the predetermined texture characteristic amount (for example, the amount of the shadow component) of a face image may be improved, while suppressing an increase in the process load.

In contrast, for example, when a shape model and a texture model corresponding to a face image size that is much smaller than the face image size in the target image OI are used in the image correction process, the amount of information on the image decreases at the time of performing the steps of the calculating of the average shape image I(W(x;p)) and the projecting into the texture eigenspace. Accordingly, even when the steps of the expanding into the average shape s₀ and the restoring to the target image OI are performed thereafter, the decreased amount of the information is not restored. Therefore, the resulting processed image may be a blurred image. Similarly, when a shape model and a texture model corresponding to a face image size that is much larger than the face image size in the target image OI are used in the image correction process, the process load in each step of the image correction process increases. Accordingly, in many embodiments, a shape model and a texture model corresponding to a face image size that is the closet to the face image size in the target image OI are used. Accordingly, the processing quality may be improved by suppressing the decrease in the amount of information on the target image OI, and an increase in the process load may be suppressed.

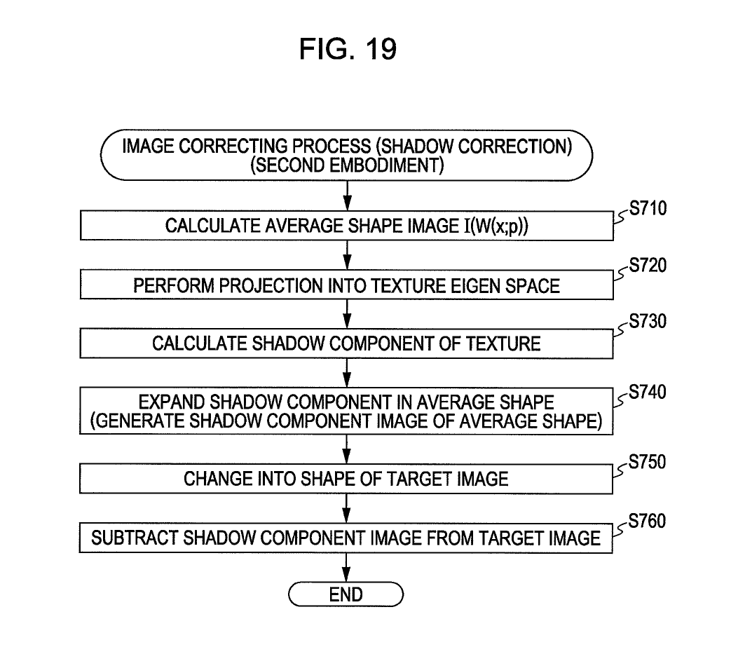

FIG. 19 is a flowchart showing steps of an image correction process, in accordance with many embodiments. The image correction process according to FIG. 19, similar to the image correction process of FIG. 17, is a process of performing correction (shadow correction) for decreasing the shadow component of a face image to a desired level for a target image OI of which the disposition of the characteristic points CP is specified by the above-described face image characteristic position specifying process (FIG. 9). In addition, in the process of FIG. 19, like the process of FIG. 17, a plurality of shape models and a plurality of texture models corresponding to different face image sizes do not need to be set, and one shape model and one texture model corresponding to an arbitrary face image size can be set.

In Step S710 (FIG. 19), the image transforming portion 241 (FIG. 1) calculates an average shape image I(W(x;p)) from the target image OI. The calculating of the average shape image I(W(x;p)) is performed in the same manner as in Step S620 of the image correction process of FIG. 17.

In Step S720 (FIG. 19), the characteristic amount processing portion 242 (FIG. 1) calculates the texture A(x) (see the above-described Equation (2)) by projecting the average shape image I(W(x;p)) into a texture eigenspace.

In Step S730 (FIG. 19), the characteristic amount processing portion 242 (FIG. 1) calculates the shadow component of the texture A(x). As described above, in many embodiments, the second texture vector A₂(x) corresponding to the second principal component of the texture A(x) is a vector that is approximately correlated with a change in the shadow component (it can be also perceived as a change in the position of the light source). In other words, a value acquired by multiplying the second texture vector A₂(x) by the texture parameter λ₂ substantially corresponds to the shadow component of the texture A(x). Accordingly, the shadow component of the texture A(x) can be calculated by changing all the values of texture parameters of the texture A(x) except for the texture parameter λ₂ of the second texture vector A₂(x) to zero.

In Step S740 (FIG. 19), the characteristic amount processing portion 242 (FIG. 1) generates a shadow component image having the average shape s₀ by expanding the shadow component of the texture A(x) in the average shape s₀. The shadow component image is an image corresponding to a predetermined texture characteristic amount called a shadow component. In Step S750, the image transforming portion 241 transforms the shape of the generated shadow component image having the average shape s₀ into the shape of the target image OI. The shape transformation performed in Step S750 is an inverse transformation of the transformation used for calculating the average shape image I(W(x;p)) in Step S710. In Step S760 (FIG. 19), the characteristic amount processing portion 242 (FIG. 1) subtracts the shadow component image transformed into the shape of the target image OI from the target image OI. By performing the above-described process, the shadow component of the face image included in the target image OI can be reduced or eliminated.

After the calculating of the shadow component of the texture A(x) is performed in Step S730 (FIG. 19), by multiplying the shadow component by a coefficient less than “1”, a decreased shadow component can be calculated. By performing the above-described process of Steps S740 to S760 for the decreased shadow component, the shadow component can decrease to a desired level without eliminating the shadow component of the face image in the target image OI.

As described above, the shadow component of the face image in the target image OI can be decreased to a desired level. In many embodiments, the calculating of the average shape image I(W(x;p)) (Step S710 shown in FIG. 19) and the projecting the average shape image I(W(x;p)) into the texture eigenspace (Step S720) are performed for calculating the shadow component of the texture A(x). In many embodiments, the correction process for decreasing the shadow component to a desired level includes subtracting the shadow component image from the original target image OI, which has not been altered via any processing. Accordingly, the quality of the process of changing the predetermined texture characteristic amount (for example, the amount of the shadow component) of the face image may be improved without decreasing the amount of information on the target image OI.

### Exemplary Variations

Furthermore, the present invention is not limited to the above-described embodiments or examples. Thus, various embodiments can be enacted without departing from the scope of the basic idea of the present invention. For example, the modifications described below can be made.

In many embodiments, in the face characteristic position specifying process (FIG. 9), selection of the shape model and the texture model is performed based on the face image size. However, in the face characteristic position specifying process, the shape model and the texture model do not need to be selected based on the face image size, and any suitable shape model and any suitable texture model can be selected.

In addition, in a case where a shape model and a texture model are selected based on the face image size in the face characteristic position specifying process (FIG. 9), the shape model and the texture model that have been selected can be configured to be selected without any change in the image correction process (FIG. 17).

In many embodiments, the image correction process is a process of performing correction for decreasing the shadow component (shadow correction) of a face image included in the target image OI to a desired level. However, the present invention can be applied to an image correction process for changing any texture characteristic amount of a face image included in the target image OI. In other words, for the texture A(x), by changing a texture parameter of a texture vector corresponding to a texture characteristic amount desired to be changed, an image correction process for changing any texture characteristic amount of a face image can be implemented.

In many embodiments, the face characteristic position specifying process (FIG. 9) is performed by using the AAM technique. However, the face characteristic position specifying process does not necessarily need to be performed by using the AAM technique and can be performed by using any other suitable method.

In addition, in many embodiments, the normalization process (Step S412) is performed in the update process for the disposition of the characteristic points CP (FIG. 15). However, the normalization process does not necessarily need to be performed.

In many embodiments, in the initial position determining process (Step S230 shown in FIG. 9) for the characteristic points CP, a differential image Ie between each of the average face image group and the target image OI and a differential image Ie between the average face image A₀(x) and each of the plurality of the average shape images I(W(x;p)) are calculated, and an approximate value of the global parameter having a great variance (large dispersion) in the entire disposition of the characteristic points CP is determined based on the differential image Ie. However, when the initial disposition of the characteristic points CP in the target image OI is performed, the calculating of the differential image Ie or the determining on the approximate value of the global parameter does not necessarily need to be performed. Thus, the predetermined disposition of the characteristic points CP (for example, the disposition corresponding to the above-described reference correspondence relationship) can be determined to be the initial disposition.

In many embodiments, as a determination index value for the convergence determination (Step S430) of the update process (FIG. 15) for the disposition of the characteristic points CP, the norm of the differential image Ie between the average shape image I(W(x;p)) and the average face image A₀(x) is used. However, as the determination index value, any other suitable index value that represents the degree of a difference between the average shape image I(W(x;p)) and the average face image A₀(x) can be used.

In many embodiments, in the updating process (FIG. 15) for the disposition of the characteristic point CP, by calculating the average shape image I(W(x;p)) based on the target image OI, the disposition of the characteristic points CP of the target image OI is matched to the disposition of the characteristic points CP of the average face image A₀(x). However, both the dispositions of the characteristic points CP can be matched to each other by performing an image transformation for the average face image A₀(x).

In many embodiments, the face area FA is detected, and the assumed reference area ABA is set based on the face area FA. However, the detection of the face area FA does not necessarily need to be performed. For example, the assumed reference area ABA can be set by user's direct designation.

The illustrated sample face images Sᵢ (FIG. 3) are only exemplary, and the number and the types of images used as the sample face images Sᵢ can be set to any suitable number and/or types. In addition, the above-described predetermined characteristic portions (see FIG. 4) of a face that are represented in the positions of the characteristic points CP are only exemplary. Thus, some of the characteristic portions set in the above-described embodiments can be omitted, or other suitable facial portions can be used as the characteristic portions.

In addition, in many embodiments, the texture model is set by performing principal component analysis for the luminance value vector that includes luminance values for each pixel group x of the sample face image SIw. However, the texture mode can be set by performing principal component analysis for index values (for example, red-green-blue (RGB) values) other than the luminance values that represent the texture of the face image.

In addition, in many embodiments, the average face image A₀(x) can have various sizes. In addition, the average face image A₀(x) does not need to include the mask area MA (FIG. 8) and can include, for example, just the average shape area BSA. Furthermore, instead of the average face image A₀(x), a different reference face image that is set based on statistical analysis of the sample face images Sᵢ can be used.

In addition, in many embodiments, the shape model and the texture model that use the AAM technique are set. However, the shape model and the texture model can be set by using any other suitable modeling technique (for example, a technique called a Morphable Model or a technique called an Active Blob).

In addition, in many embodiments, an image stored in the memory card MC includes the target image OI. However, for example, the target image OI can be an image that is acquired elsewhere, for example, through a network.

In addition, the configuration of the printer 100 as the image processing apparatus according to each of the above-described embodiments is merely an example, and the configuration of the printer 100 can be changed in various forms. For example, the image transforming portion 212 and the image transforming portion 241 do not need to have configurations independent of each other and can have one common configuration. In addition, in many embodiments, the image processing performed by using the printer 100 as an image processing apparatus has been described. However, a part or all of the above-described processing can be performed by an image processing apparatus of any other suitable type such as a personal computer, a digital still camera, or a digital video camera. In addition, the printer 100 is not limited to an ink jet printer and can be a printer of any other suitable type such as a laser printer or a sublimation printer.

A part of the configuration that is implemented by hardware can be replaced by software. Likewise, a part of the configuration implemented by software can be replaced by hardware.

In addition, in a case where a part of or the entire function according to an embodiment of the invention is implemented by software, the software (computer program) may be provided in a form being stored on a computer-readable recording medium. The “computer-readable recording medium” is not limited to a portable recording medium such as a flexible disk or a CD-ROM and includes various types of internal memory devices of a computer such a RAM and a ROM and an external memory device such as a hard disk that is fixed to a computer.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. An image processing apparatus that changes a predetermined texture characteristic amount of a face image in a target image, the image processing apparatus comprising:
a processor; and
a machine readable memory coupled with the processor and comprising
information used for specifying a plurality of reference face shapes corresponding to different face image sizes,
a plurality of texture models, each of the texture models corresponding to one of the plurality of reference face shapes and defined by pixel values of a face image having the corresponding reference face shape, each texture model comprising a reference texture and at least one texture characteristic amount therein, and
instructions that when executed cause the processor to
specify positions of predetermined characteristic portions of the face image in the target image;
determine a size of the face image in the target image,
select one of the reference face shapes based on the determined face image size;
select a texture model corresponding to the selected reference face shape from the plurality of texture models;
perform a first transformation of the face image in the target image such that a face shape defined by the positions of characteristic portions in the resulting transformed face image is identical to the selected reference face shape;
change the predetermined texture characteristic amount of the transformed face image by using the selected texture model; and
perform a second transformation of the transformed face image having the changed predetermined texture characteristic amount, the second transformation being the inverse of the first transformation.

2. The image processing apparatus according to claim 1, wherein the selected reference face shape and the selected texture model correspond to a face image size that is closest to the determined face image size.

3. The image processing apparatus according to claim 1, wherein the selected texture model is used to generate texture characteristic amounts for the transformed face image, the generated texture characteristic amounts comprising the predetermined texture characteristic amount.

4. The image processing apparatus according to claim 1, wherein the predetermined texture characteristic amount substantially corresponds to a shadow component.

5. The image processing apparatus according to claim 1, wherein the face image size in the target image is determined based on the specified positions of the characteristic portions of the face image in the target image.

6. The image processing apparatus according to claim 1,
wherein the information used for specifying a plurality of reference face shapes comprises a plurality of shape models, each shape model representing a face shape by using one of the reference face shapes and at least one shape characteristic amount, the plurality of reference face shapes comprising face shapes having different face image sizes; and
wherein the positions of the characteristic portions of the face image in the target image are specified by using a selected shape model and the selected texture model.

7. The image processing apparatus according to claim 6, wherein the selected shape model and the selected texture model were created based on statistical analysis of a plurality of sample face images of which the positions of the characteristic portions are known.

8. The image processing apparatus according to claim 7,
wherein the selected reference face shape is an average shape that represents average positions of the characteristic portions of the plurality of sample face images; and
wherein the selected texture model comprises a reference texture that includes averages of pixel values of a plurality of transformed sample face images generated by transforming each of the plurality of sample face images into the average shape.

9. An image processing method for changing a predetermined texture characteristic amount of a face image in a target image, the image processing method using a computer comprising:
specifying positions of predetermined characteristic portions of the face image in the target image;
determining a size of the face image in the target image;
selecting one of a plurality of reference face shapes corresponding to different face image sizes based on the determined face image size;
selecting a texture model corresponding to the selected reference face shape from a plurality of texture models, each of the plurality of texture models comprising a reference texture and at least one texture characteristic amount therein;
performing a first transformation of the face image in the target image such that a face shape defined by the positions of characteristic portions in the resulting transformed face image is identical to the selected reference shape;
changing the predetermined texture characteristic amount of the transformed face image by using the selected texture model; and
performing a second transformation of the transformed face image having the changed predetermined texture characteristic amount, the second transformation being the inverse of the first transformation.

10. The method according to claim 9, further comprising:
acquiring information used for specifying the plurality of reference face shapes and the plurality of texture models, wherein each texture model is defined by pixel values of a face image having the shape of one of the reference face shapes.

11. A tangible medium containing a computer program implementing the method according to claim 9.

12. A tangible medium containing a computer program implementing the method according to claim 10.

13. An image processing method for changing at least one predetermined texture characteristic amount of a face image in a target image, the image processing method comprising:
specifying positions of predetermined characteristic portions of the face image in the target image;
performing a first transformation of the face image such that a face shape defined by the positions of the characteristic portions in the resulting transformed face image is identical to a predetermined reference face shape;
determining texture characteristic amounts for the transformed face image based on a texture model corresponding to the reference face shape;
determining a shadow component for the face image in response to the determined texture characteristic amounts;
determining a shadow component image having the same shape as the reference face shape;
performing a second transformation of the shadow component image, the second transformation being the inverse of the first transformation; and
subtracting the shadow component image from the target image.
